(19) United States
(12) Patent Application Publication
(10) Pub. No.: US 2024/0342829 A1
(43) Pub. Date: Oct. 17, 2024

(54) LASER PROCESSING APPARATUS AND PROCESSING METHOD THEREOF

(71) Applicant: E&R ENGINEERING CORPORATION, Kaohsiung City (TW)

(72) Inventor: Schang-Jing HON, Kaohsiung City (TW)

(21) Appl. No.: 18/320,741

(22) Filed: May 19, 2023

(30) Foreign Application Priority Data
Apr. 11, 2023 (TW) 112113391

(51) Int. Cl. B23K 26/08; B23K 26/06; B23K 26/382

(52) U.S. Cl. CPC B23K 26/0876; B23K 26/0643; B23K 26/0648; B23K 26/382

(57) ABSTRACT

A laser processing apparatus and a processing method thereof has a laser generator, a stage, a galvo mirror module, a focusing lens module, and a controller. The controller has an arithmetic logic unit for stratifying multiple targets at a substrate into multiple beam path layers. The stage is controlled by the controller to move along a first axis forwardly and backwardly. During each of forward movements and backward movements of the stage, the laser generator and a galvo mirror module are controlled by the controller according to a respective one of the beam path layers for processing the targets stratified in the beam path layer. All the targets at the substrate are processed in sequence while the stage is continuously moving along the first axis forwardly and backwardly. The substrate can be rapidly processed with good processing quality.

### BACKGROUND OF THE INVENTION

### 1. Field of the Invention

The present invention relates to a laser processing apparatus and processing method thereof, and more particularly to a laser processing apparatus and processing method that can rapidly process a substrate and maintain good processing quality of the substrate.

### 2. Description of the Prior Art

A conventional laser process has been applied for forming through silicon vias (TSV) or through glass vias (TGV). In the present laser process, multiple targets to form vias are determined at a substrate and are modified by irradiating via a laser beam. Then the targets are etched to form the vias.

A conventional laser processing apparatus substantially comprises a laser generator, a stage, and a galvo mirror module. The laser generator is configured to output a laser beam. The stage is movable and is configured to carry a substrate. The galvo mirror module is configured to deflect the laser beam to shift a pointing position of the laser beam relative to the stage. When the conventional laser processing apparatus is in use, firstly, the laser beam is deflected by the galvo mirror module to sequentially focus at multiple targets at a processing area of the substrate one by one. Secondly, the substrate is moved by the stage to shift the position of the substrate relative to the galvo mirror module. And then, the laser beam is deflected by the galvo mirror module again to sequentially focus at multiple targets at a next processing area of the substrate one by one. The conventional laser processing apparatus may process 100 targets per second.

Since a speed at which the galvo mirror module deflects the laser beam to shift and point the laser beam at the substrate is faster than a speed at which the stage moves the substrate to adjust the position of the substrate relative to the laser beam, the larger a scanning area of the galvo mirror module, the fewer times the stage has to move, and the substrate can be processed faster. However, when the scanning area of the galvo mirror module is larger, a deformation of the laser beam being focused is larger, a depth of focus of the focused laser beam is longer, and the energy of the focused laser is dispersed. Accordingly, modification regions, at the substrate, formed by the focused laser beam has poor qualities.

When a scanning area of the galvo mirror module is smaller, the deformation of the focused laser beam is smaller, a depth of focus of the focused laser beam could be shorter, and the energy of the focused laser beam is concentrated. Whereby, qualities of the modification regions, at the substrate, formed by the laser beam are promoted. However, if the scanning area of the galvo mirror module is smaller, the stage needs to move more times, so a manufacturing lead time for processing a substrate is prolonged. Moreover, because the galvo mirror module has the small scanning area, a moving distance of the stage per time is shorter; as soon as the stage starts to speed up, it has to be braked to stop. It will take longer time as the stage moves a small distance for more times.

Accordingly, the conventional laser processing apparatus cannot rapidly process and provide good processing quality at the same time.

To overcome the shortcomings, the present invention provides a laser processing apparatus to mitigate or obviate the aforementioned problems.

### SUMMARY OF THE INVENTION

The main objective of the present invention is to provide a laser processing apparatus to rapidly process a substrate with good processing quality.

The laser processing apparatus is configured for processing multiple targets at a substrate and comprises a first axis, a second axis intersecting the first axis, a laser generator configured to provide a laser beam, a stage being movable and configured to carry said substrate, a galvo mirror module configured to deflect the laser beam and having a scanning range along the second axis, a focusing lens module configured to focus the laser beam, and a controller coupled to the laser generator, the stage, and the galvo mirror module and including an arithmetic logic unit. The arithmetic logic unit is configured for stratifying said multiple targets into multiple beam path layers according to the scanning range of the galvo mirror module along the second axis. Each beam path layer includes multiple said targets. The stage is controlled by the controller to repeatedly move along the first axis forwardly and backwardly at a constant velocity, wherein a forward movement is defined as a movement of the stage moving along the first axis forwardly and a backward movement is defined as a movement of the stage moving along the first axis backwardly. During each forward movement or each backward movement of the stage moving along the first axis at the constant velocity, the laser generator and the galvo mirror module are controlled by the controller according to a respective one of the beam path layers. Wherein, a time interval and a spaced interval between each consecutive two of the targets of each beam path layer are determined by the arithmetic logic unit according to the constant velocity of the stage moving along the first axis. The laser generator is controlled by the controller according to the time interval to shoot the laser beam, and the galvo mirror module is controlled by the controller according to the spaced interval to deflect the laser beam within the time interval to adjust a focusing position of the laser beam at the substrate.

A processing method of a laser processing apparatus configured for processing multiple targets at a substrate, said laser processing apparatus comprises a first axis, a second axis intersecting the first axis, and a controller coupled to a laser generator, a stage, and a galvo mirror module. The galvo mirror module has a scanning range along the second axis. The controller includes an arithmetic logic unit. The processing method of the laser processing apparatus comprises steps as follows:
the multiple targets are stratified into multiple beam path layers by the arithmetic logic unit according to the scanning range of the galvo mirror module along the second axis, each beam path layer including multiple said targets;
the stage is controlled by the controller to move along the first axis forwardly and backwardly at a constant velocity, repeatedly, wherein a forward movement is defined as a movement of the stage moving along the first axis forwardly and a backward movement is defined as a movement of the stage moving along the first axis backwardly;
during each forward movement or each backward movement of the stage that moves along the first axis at the constant velocity, the laser generator and the galvo mirror module are controlled by the controller according to a respective one of the beam path layers, wherein a time interval and a spaced interval between each consecutive two of the targets of each beam path layer are determined by the arithmetic logic unit according to the constant velocity of the stage moving along the first axis;
the laser generator is controlled by the controller according to the time interval to shoot a laser beam and the galvo mirror module is controlled by the controller according to the spaced interval to deflect the laser beam within the time interval to adjust a focusing position of the laser beam at the substrate.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a laser processing apparatus in accordance with the present invention;

FIG. 2 is a perspective schematic view of the laser processing apparatus in FIG. 1;

FIG. 3 is an enlarged perspective schematic view of the laser processing apparatus in FIG. 2;

FIG. 4 is an operational schematic view of the laser processing apparatus in FIG. 1 showing movements of a stage and a laser beam;

FIG. 5 is a schematic view of a substrate showing multiple targets at a substrate to be shot by the laser beam;

FIG. 6 is a schematic view showing that an arithmetic logic unit stratifies the multiple targets at the substrate in FIG. 5 into multiple beam path layers;

FIG. 7 is an operational schematic view showing that the laser processing apparatus processes the substrate according to the beam path layer L1 in FIG. 6;

FIG. 8 is an operational schematic view showing that the laser processing apparatus processes the substrate according to the beam path layer L2 in FIG. 6; and

FIG. 9 is an operational schematic view showing that the laser processing apparatus processes the substrate according to the beam path layer Ln in FIG. 6.

### DETAILED DESCRIPTION OF THE PREFERRED EMBODIMENTS

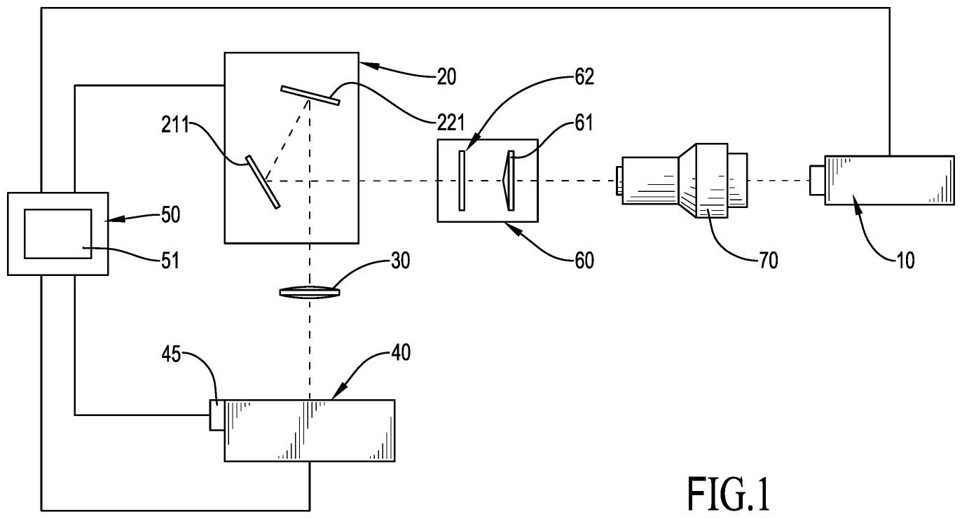

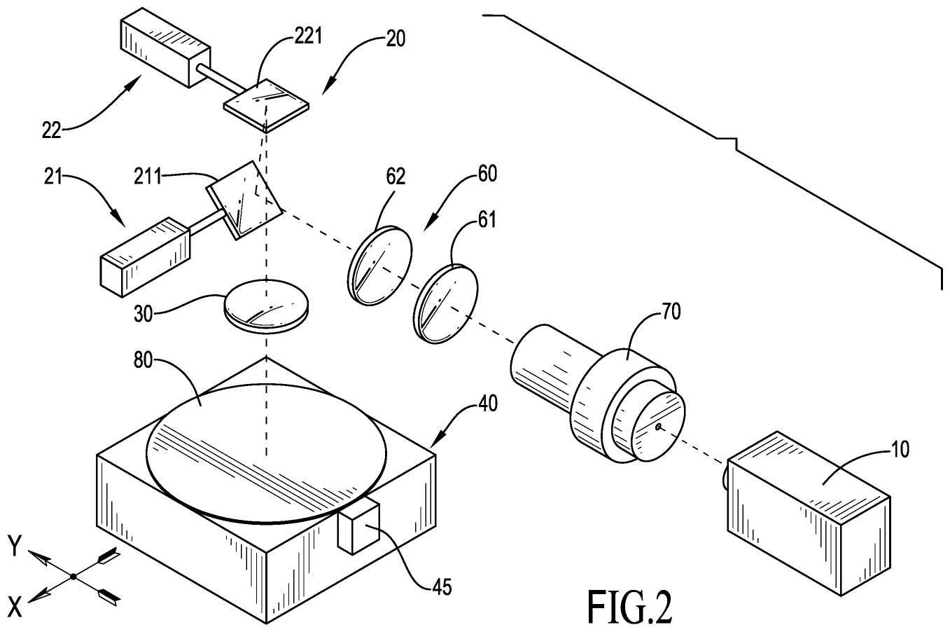

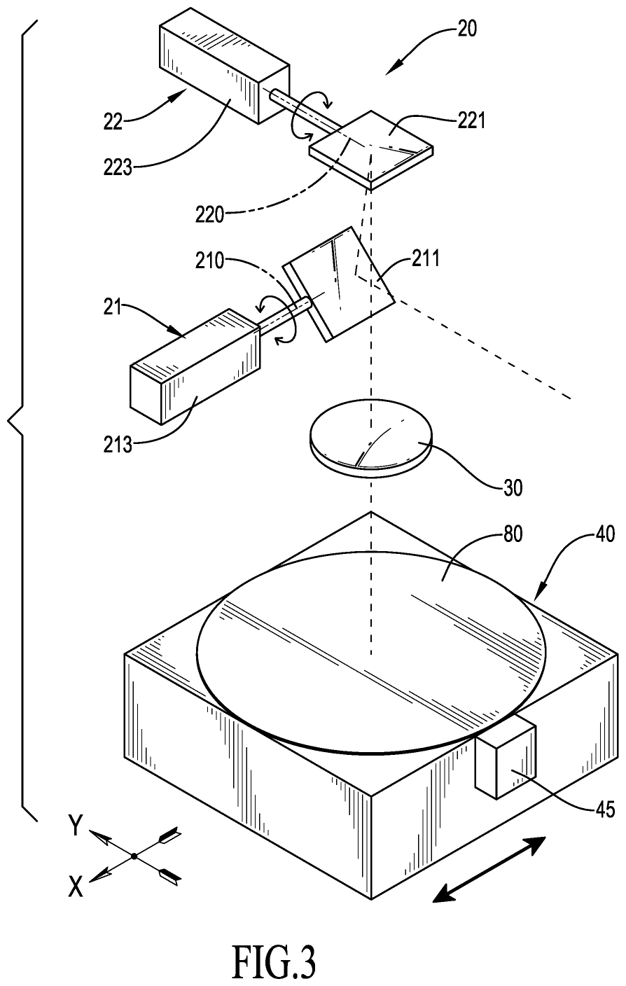

With reference to FIGS. 1 to 3, and 6, a laser processing apparatus in accordance with the present invention is configured for processing multiple targets P at a substrate 80 and comprises a laser generator 10, a stage 40, a galvo mirror module 20, a focusing lens module 30, a controller 50, a first axis X, and a second axis Y. The second axis Y intersects the first axis X. Preferably, the first axis X and the second axis Y are perpendicular to each other.

The laser generator 10 is configured to provide a laser beam. The stage 40 is movable and is configured to carry said substrate 80. The galvo mirror module 20 is located between the laser generator 10 and the stage 40, is configured to deflect the laser beam, and has a scanning range along the second axis Y. The focusing lens module 30 is located between the galvo mirror module 20 and the stage 40 and is configured for focusing the laser beam. The controller 50 is coupled to the laser generator 10, the stage 40, and the galvo mirror module 20 and includes an arithmetic logic unit 51.

With reference to FIGS. 1 to 3, and 6, the arithmetic logic unit 51 is configured for stratifying said multiple targets P at the substrate 80 into multiple beam path layers L1, L2. . . . Ln according to the scanning range of the galvo mirror module 20 along the second axis Y. Each beam path layer L1, L2. . . . Ln includes multiple said targets P.

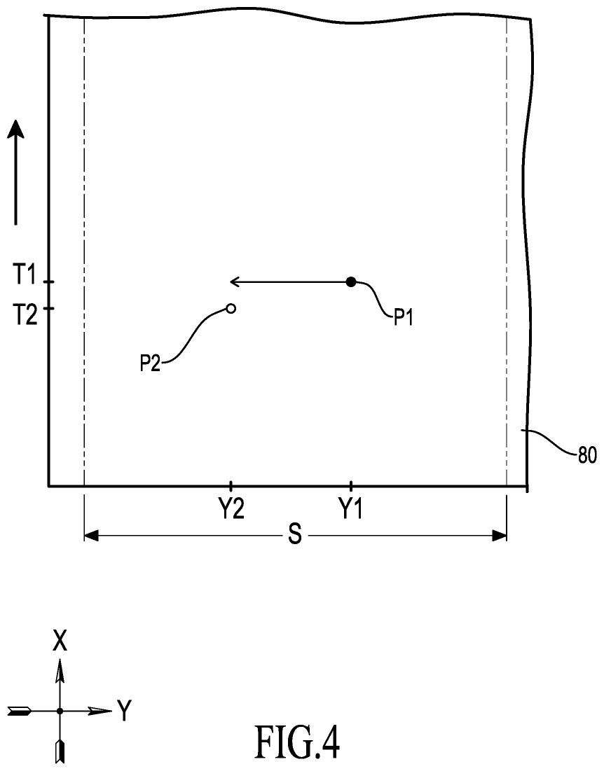

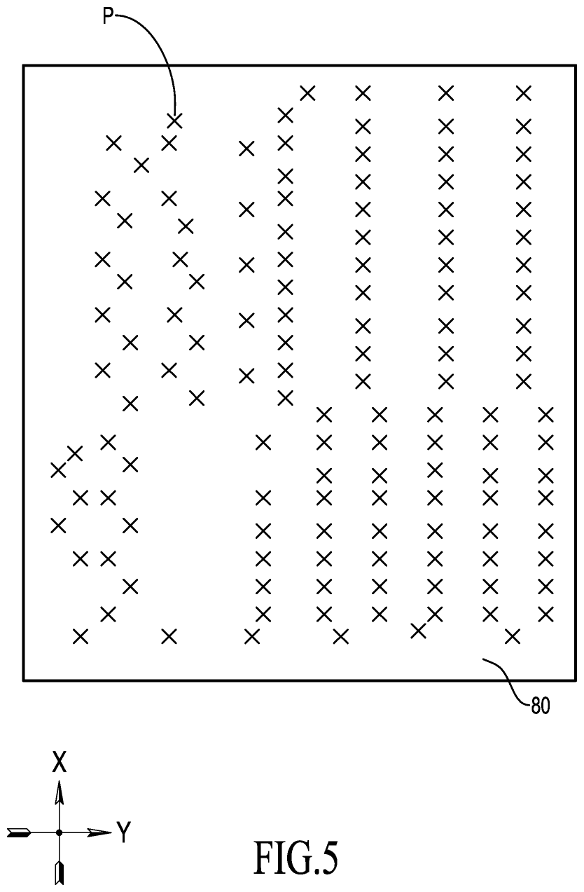

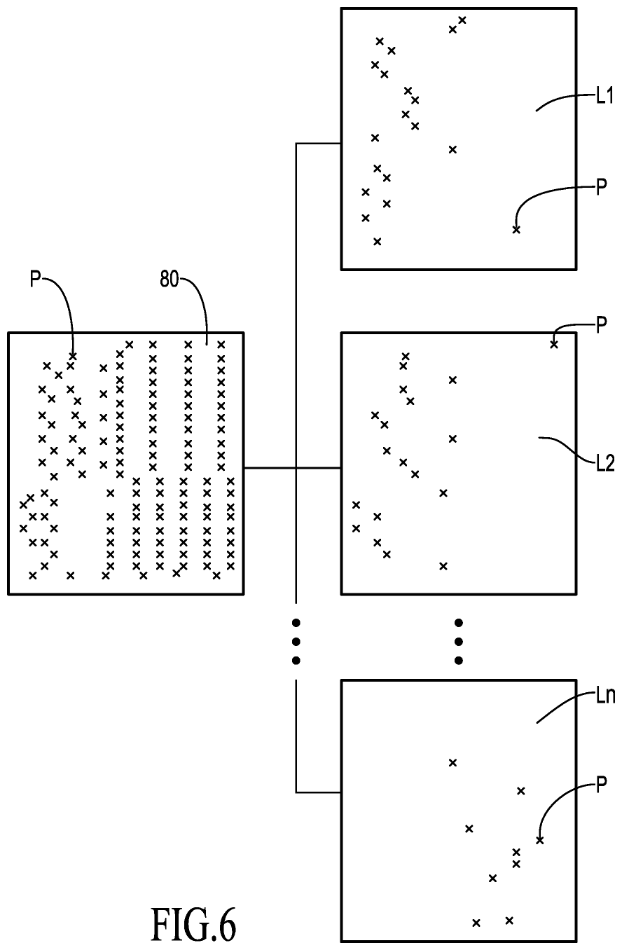

With reference to FIGS. 1, 4, to 6, FIG. 4 shows the scanning range S of the galvo mirror module 20 along the second axis Y. FIG. 5 shows the targets P, at the substrate 80, that are determined to be shot by the laser beam. FIG. 6 shows that the multiple targets P at the substrate 80 are stratified into multiple beam path layers L1, L2. . . . Ln by the arithmetic logic unit 51, and each beam path layer L1, L2. . . . Ln includes multiple said targets P.

With reference to FIGS. 1 to 3, and 6, the stage 40 is controlled by the controller 50 to repeatedly move along the first axis X forwardly and backwardly at a constant velocity. Wherein, a forward movement is defined as a movement of the stage 40 moving along the first axis X forwardly and a backward movement is defined as a movement of the stage 40 moving along the first axis X backwardly. During each of the forward movements or each of the backward movements of the stage 40 moving along the first axis X at the constant velocity, the laser generator 10 and the galvo mirror module 20 are controlled by the controller 50 according to a respective one of the beam path layers L1, L2. . . . Ln.

With reference to FIGS. 1 to 4, because the stage 40 moves along the first axis X at the constant velocity during each of the forward movements and each of the backward movements, there is a linear relationship between moving time of the stage 40 along the first axis X and position of the stage 40 relative to the first axis X. Accordingly, as shown in FIG. 4, a distance between two consecutive targets P1, P2 along the first axis X can be converted into a time interval (T2-T1) for the stage 40 moving along the first axis X, wherein the time interval is longer than a reacting time of the galvo mirror module 20. Focusing positions of the laser beam are respectively determined according to coordinates Y1, Y2 of the two consecutive targets P1, P2 along the second axis Y. If the laser beam is focused to target P1 at T1, the galvo mirror module 20 only needs to be adjusted for deflecting the laser beam from Y1 to Y2, within the time interval (T2-T1) for the stage 40, carrying the substrate 80, so that the laser beam can be focused to target P2 at T2.

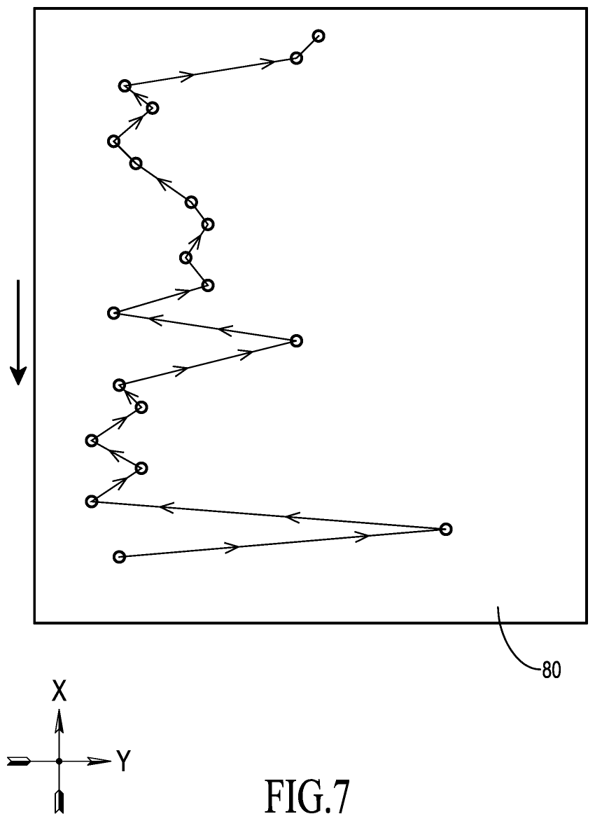

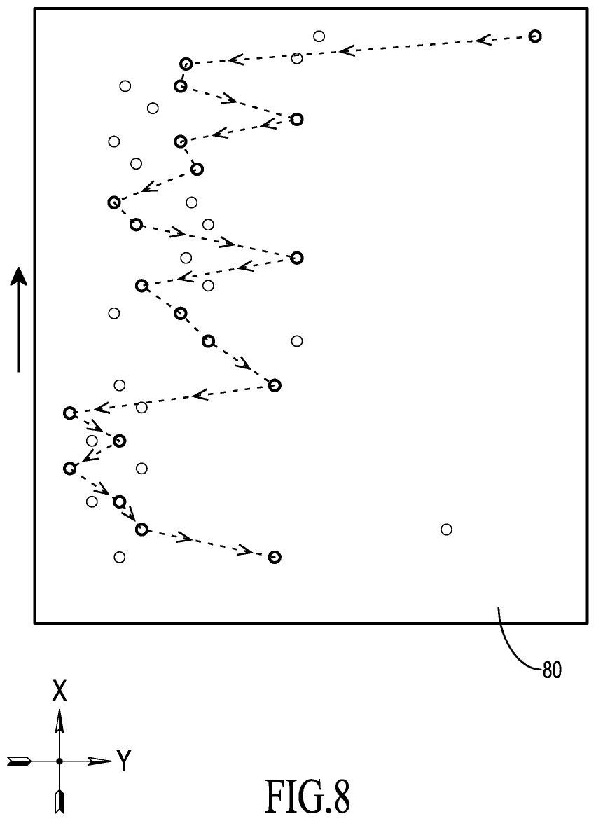

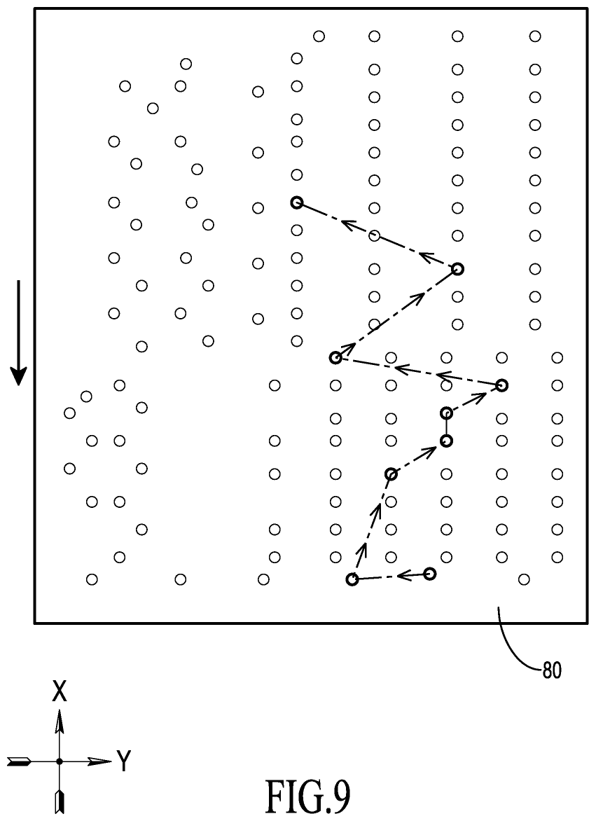

With reference to FIGS. 1, 6 to 9, a time interval and a spaced interval between each consecutive two of the targets P of each beam path layer L1, L2. . . . Ln are determined by the arithmetic logic unit 51. The arithmetic logic unit 51 determined said time interval and said spaced interval according to moving time and relative position of the stage 40 moving along the first axis X at the constant velocity. The laser generator 10 is controlled by the controller 50 according to the time interval to shoot the laser beam. The galvo mirror module 20 is controlled by the controller 50 according to the spaced interval to deflect the laser beam within the time interval to adjust a focusing position of the laser beam at the substrate 80. FIG. 7 shows that during a forward movement of the stage 40 along the first axis X, the laser beam is sequentially focused to the targets P stratified into the beam path layer L1 in FIG. 6 at the substrate 80. FIG. 8 shows that during a backward movement of the stage 40 along the first axis X, the laser beam sequentially focuses on the targets P stratified into the beam path layer L2 in FIG. 6 at the substrate 80. FIG. 9 shows that during a forward movement of the stage 40 along the first axis X, the laser beam sequentially focuses on the targets P stratified into the beam path layer Ln in FIG. 6 at the substrate 80. While the stage 40 is continuously moving along the first axis X forwardly and backwardly, the laser beam sequentially focuses on the targets P at the substrate 80 according to the multiple beam path layers L1, L2. . . . Ln in sequence, till all of the targets P at the substrate 80 have been processed.

With reference to FIGS. 1 to 3, the galvo mirror module 20 includes at least one reflecting mirror 211, 221 being rotatable and at least one galvo driving device 213, 223 driving the at least one reflecting mirror 211, 221 to rotate to deflect the laser beam to adjust a focusing position of the laser beam relative to the substrate 80. In the embodiment, the galvo mirror module 20 includes a first mirror set 21 and a second mirror set 22. The first mirror set 21 has a first rotating axis 210, a first reflecting mirror 211, and a first galvo driving device 213 driving the first reflecting mirror 211 to rotate along the first rotating axis 210 to deflect the laser beam along the second axis Y. The second mirror set 22 has a second rotating axis 220, a second reflecting mirror 221, and a second galvo driving device 223 driving the second reflecting mirror 221 to rotate along the second rotating axis 220 to deflect the laser beam along the first axis X. Therefore, the galvo mirror module 20 can deflect the laser beam along the first axis X and the second axis Y.

With reference to FIGS. 1 to 3, preferably, the laser processing apparatus further comprises a position sensor 45 coupled to the controller 50 and configured to detect a position of the stage 40 along the first axis X and transmit a detecting signal to the controller 50. The controller 50 calibrates the time interval and the spaced interval to reduce deviation according to the detecting signal.

Preferably, the laser processing apparatus further comprises a lens set 60 located between the laser generator 10 and the galvo mirror module 20. The lens set 60 includes at least one lens 61, 62 to shape the laser beam. A beam expander 70 is located between the lens set 60 and the laser generator 10. The beam expander 70 may be a conventional beam expander and is adapted to increase a beam diameter of the laser beam emitted from the laser generator 10 and to reduce divergence of the laser beam, hereby, increasing the laser fluence of the focused laser beam.

If a width of the substrate 80 along the second axis Y is larger than the scanning range S of the galvo mirror module 20 along the second axis Y, the arithmetic logic unit 51 will determine multiple beam path layers L1, L2. . . . Ln according to positions of the targets P at the substrate 80 to be processed and the scanning range S of the galvo mirror module 20 along the second axis Y. Each beam path layer L1, L2. . . . Ln has a range along the second axis Y smaller than or equal to the scanning range S. Part of the beam path layers L1, L2. . . . Ln have positions relative to the substrate 80 along the second axis Y, which May be different from the positions of part of the other beam path layers L1, L2. . . . Ln. Whereby, all the targets P at the substrate 80 can be stratified into the multiple beam path layers L1, L2. . . . Ln. Before processing the substrate 80 according to each beam path layer L1, L2. . . . Ln, the stage 40 is controlled by the controller 50 according to the position of the beam path layer L1, L2. . . . Ln relative to the substrate 80 to move along the second axis Y. Specifically, the targets P at an elongated region of the substrate 80 corresponding to the scanning range S can be firstly processed, and then the stage 40 is controlled to move along the second axis Y for processing the targets P at a next elongated region of the substrate 80. In another embodiment, the stage 40 may be controlled to move along the second axis Y, progressively. For example, after all of the targets P at a left edge of the substrate 80 have been processed, the stage 40 can be controlled to move left along the second axis Y, whereby, the position of the scanning range S of the galvo mirror module 20 relative to the substrate 80 is moved right. So each beam path layer L1, L2. . . . Ln is kept to have more targets P.

Since all of the targets P are stratified into the multiple beam path layers L1, L2. . . . Ln to be processed, and the stage 40 moves along the first axis X forwardly and backwardly at the constant velocity, the stage 40 can be kept moving at a high speed to significantly increase processing speed. Accordingly, the galvo mirror module 20 can have a smaller scanning range S, and a processing period for processing a substrate 80 can be decreased with good processing quality.

To process a substrate 80 with 594,550 targets P, if the constant velocity of the stage 40 moving along the first axis X is 200 millimeters per second (mm/s), the scanning range S of the galvo mirror module 20 along the second axis Y is 2 millimeters (mm), the reacting time of the galvo mirror module 20 is 500 micro seconds (μs), and an amount of the beam path layers L1, L2. . . . Ln is 252, the total processing time will be 695.155 seconds(s), and the laser processing apparatus will be able to process 855 targets P per second. If the constant velocity of the stage 40 moving along the first axis X is 300 millimeters per second (mm/s), the scanning range S of the galvo mirror module 20 along the second axis Y is 2 millimeters (2 mm), the reacting time of the galvo mirror module 20 is 350 micro seconds (μs), and the amount of the beam path layers L1, L2. . . . Ln is 252, the total processing time will be 497.036 seconds(s), and the laser processing apparatus will be able to process 1197 targets P per second. If the constant velocity of the stage 40 moving along the first axis X is 300 millimeters per second (mm/s), the scanning range S of the galvo mirror module 20 along the second axis Y is 3 millimeters (3 mm), the reacting time of the galvo mirror module 20 is 350 micro seconds (μs), and an amount of the beam path layers L1, L2. . . . Ln is 192, the total processing time will be 378.694 seconds(s), and the laser processing apparatus will be able to process 1570 targets P per second.

As the stage 40 moves along the first axis X at the constant velocity, there is a linear relationship between the position of the substrate 80 along the first axis X and the moving time. Variables are few, so the relative relationship between time and position can be accurately predicted. The laser generator 10 is triggered by programming time schedule. The galvo mirror module 20 is controlled to adjust the focusing position of the laser beam at the substrate 80. Time interval between each two consecutive targets P is short. The laser beam can be accurately controlled to focus on the targets P at the substrate 80, sequentially.

What is claimed is:

1. A laser processing apparatus configured for processing multiple targets at a substrate and comprising:
a first axis;
a second axis intersecting the first axis;
a laser generator configured to provide a laser beam;
a stage being movable and configured to carry the substrate;
a galvo mirror module configured to deflect the laser beam and having a scanning range along the second axis;
a focusing lens module configured for focusing the laser beam; and
a controller coupled to the laser generator, the stage, and the galvo mirror module and including
an arithmetic logic unit configured for stratifying said multiple targets into multiple beam path layers according to the scanning range of the galvo mirror module along the second axis, each beam path layer including multiple said targets; wherein
the stage is controlled by the controller to repeatedly move along the first axis forwardly and backwardly at a constant velocity, wherein a forward movement is defined as a movement of the stage moving along the first axis forwardly and a backward movement is defined as a movement of the stage moving along the first axis backwardly;
during each forward movement or each backward movement of the stage moving along the first axis at the constant velocity, the laser generator and the galvo mirror module are controlled by the controller according to a respective one of the beam path layers, wherein a time interval and a spaced interval between each consecutive two of the targets of each beam path layer are determined by the arithmetic logic unit according to the constant velocity of the stage moving along the first axis;
the laser generator is controlled by the controller according to the time interval to shoot the laser beam and the galvo mirror module is controlled by the controller according to the spaced interval to deflect the laser beam within the time interval to adjust a focusing position of the laser beam at the substrate.

2. The laser processing apparatus in claim 1, wherein the first axis and the second axis are perpendicular to each other.

3. The laser processing apparatus in claim 2, wherein the laser processing apparatus comprises a position sensor coupled to the controller to detect a position of the stage along the first axis and to transmit a detecting signal to the controller;
the time interval and the spaced interval are calibrated by the controller according to the detecting signal for reducing deviation.

4. The laser processing apparatus in claim 3, wherein the stage is controlled by the controller according to each beam path layer to move along the second axis according to a position of the beam path layer relative to the substrate along the second axis.

5. The laser processing apparatus in claim 1, wherein the galvo mirror module includes at least one reflecting mirror being rotatable and at least one galvo driving device driving the at least one reflecting mirror to rotate to deflect the laser beam.

6. The laser processing apparatus in claim 2, wherein the galvo mirror module includes at least one rotatable reflecting mirror and at least one galvo driving device driving the at least one reflecting mirror to rotate to deflect the laser beam.

7. The laser processing apparatus in claim 3, wherein the galvo mirror module includes at least one rotatable reflecting mirror and at least one galvo driving device driving the at least one reflecting mirror to rotate to deflect the laser beam.

8. The laser processing apparatus in claim 4, wherein the galvo mirror module includes at least one rotatable reflecting mirror and at least one galvo driving device driving the at least one reflecting mirror to rotate to deflect the laser beam.

9. The laser processing apparatus in claim 5, wherein the laser processing apparatus comprises a lens set located between the laser generator and the galvo mirror module and having at least one lens.

10. The laser processing apparatus in claim 6, wherein the laser processing apparatus comprises a lens set located between the laser generator and the galvo mirror module and having at least one lens.

11. The laser processing apparatus in claim 7, wherein the laser processing apparatus comprises a lens set located between the laser generator and the galvo mirror module and having at least one lens.

12. The laser processing apparatus in claim 8, wherein the laser processing apparatus comprises a lens set located between the laser generator and the galvo mirror module and having at least one lens.

13. The laser processing apparatus in claim 9, wherein a beam expander is located between the lens set and the laser generator.

14. The laser processing apparatus in claim 10, wherein a beam expander is located between the lens set and the laser generator.

15. The laser processing apparatus in claim 11, wherein a beam expander is located between the lens set and the laser generator.

16. The laser processing apparatus in claim 12, wherein a beam expander is located between the lens set and the laser generator.

17. A processing method of a laser processing apparatus configured for processing multiple targets at a substrate, wherein the laser processing apparatus comprises a first axis, a second axis intersecting the first axis, and a controller coupled to a laser generator, a stage, and a galvo mirror module, the galvo mirror module has a scanning range along the second axis, and the controller includes an arithmetic logic unit; wherein the processing method of the laser processing apparatus comprises steps as follows:
the multiple targets are stratified into multiple beam path layers by the arithmetic logic unit according to the scanning range of the galvo mirror module along the second axis, each beam path layer including multiple said targets;
the stage is controlled by the controller to move along the first axis forwardly and backwardly at a constant velocity, repeatedly, wherein a forward movement is defined as a movement of the stage moving along the first axis forwardly and a backward movement is defined as a movement of the stage moving along the first axis backwardly;
during each forward movement or each backward movement of the stage that moves along the first axis at the constant velocity, the laser generator and the galvo mirror module are controlled by the controller according to a respective one of the beam path layers, wherein a time interval and a spaced interval between each consecutive two of the targets of each beam path layer are determined by the arithmetic logic unit according to the constant velocity of the stage moving along the first axis;
the laser generator is controlled by the controller according to the time interval to shoot a laser beam and the galvo mirror module is controlled by the controller according to the spaced interval to deflect the laser beam within the time interval to adjust a focusing position of the laser beam at the substrate.

18. The processing method of the laser processing apparatus in claim 17, wherein
said laser processing apparatus comprises a position sensor coupled to the controller to detect a position of the stage along the first axis and to transmit a detecting signal to the controller;
the time interval and the spaced interval are calibrated by the controller according to the detecting signal for reducing deviation.

19. The processing method of the laser processing apparatus in claim 18, wherein the stage is controlled by the controller according to each beam path layer to move along the second axis according to a position of the beam path layer relative to the substrate along the second axis.
